(19) United States
(12) Patent Application Publication
(10) Pub. No.: US 2021/0349705 A1
(43) Pub. Date: Nov. 11, 2021

(54) PERFORMANCE SENSITIVE STORAGE SYSTEM UPGRADE

(71) Applicant: International Business Machines Corporation, Armonk, NY (US)

(72) Inventors: Ben Sasson, North Baddesley (GB); Lee Jason Sanders, Chichester (GB); Gordon Douglas Hutchison, Eastleigh (GB); Gareth Paul Jones, Hampshire (GB)

(21) Appl. No.: 16/867,061

(22) Filed: May 5, 2020

(51) Int. Cl. G06F 8/65; G06F 3/06

(52) U.S. Cl. CPC G06F 8/65; G06F 3/0673; G06F 3/0653; G06F 3/0607

(57) ABSTRACT

A processor may identify a storage system having a cluster of multiple nodes with redundancy for sharing a load of host input/output (IO) operations. The processor may upgrade one or more nodes at a time making use of redundancy. The processor may collect performance statistics of the storage system with the upgraded nodes during active use of the host IO operations. The processor may compare the collected performance statistics with historical performance statistics for the storage system. If the upgraded nodes show a negative performance impact, the processor may take remedial action. Otherwise, the processor may continue to upgrade the remaining nodes.

### BACKGROUND

The present disclosure relates to upgrading storage systems, and more specifically, to performance sensitive storage system upgrades in a storage system cluster.

Storage products sit in the heart of many computer environments and require periodic updates to enable new features and other improvements. While all vendors attempt to deliver performance improvement as part of the process, some changes may cause overall performance degradation for some customers. This could be due to many reasons, ranging from a no-longer-optimal configuration to untested conditions and code bugs. Since many host applications are performance sensitive and might stop working properly due to degraded performance, a seemingly successful upgrade may result in an overall environment failure.

Many storage systems work in a form of a cluster, where multiple identical and redundant servers share the load of the host input/output (IO) operations while allowing a single component to “disappear” without the hosts noticing a significant change in system response time or latency.

Clustering environments also allow non-disruptive code upgrades, by upgrading a single component at a time and, only once all components have the new code loaded on them, completing the upgrade.

A customer would usually only notice a performance degradation after an upgrade has been completed and committed and rollback would be difficult to perform, for example, for a new feature now in use.

### SUMMARY

Embodiments of the present disclosure include a method, system, and computer program product for a performance sensitive storage system upgrade. A processor may identify a storage system having a cluster of multiple nodes with redundancy for sharing a load of host input/output (IO) operations. The processor may upgrade one or more nodes at a time making use of redundancy. The processor may collect performance statistics of the storage system with the upgraded nodes during active use of the host IO operations. The processor may compare the collected performance statistics with historical performance statistics for the storage system. If the upgraded nodes show a negative performance impact, the processor may take remedial action. Otherwise, the processor may continue to upgrade the remaining nodes.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a flow diagram of an example embodiment of a method, in accordance with embodiments of the present disclosure;

FIGS. 2A to 2F are schematic diagrams illustrating an example embodiment of a method, in accordance with embodiments of the present disclosure;

FIG. 3 is block diagram of an example embodiment of a system, in accordance with embodiments of the present disclosure;

FIG. 4 is a block diagram of an embodiment of a computer system or cloud server in which the present disclosure may be implemented;

FIG. 5 is a schematic diagram of a cloud computing environment in which the present disclosure may be implemented; and

FIG. 6 is a diagram of abstraction model layers of a cloud computing environment in which the present disclosure may be implemented.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to upgrading storage systems, and more specifically, to performance sensitive storage system upgrades in a storage system cluster.

In some embodiments, performance sensitive storage system upgrades are described that analyze a storage system's performance during the upgrade process and take remedial action if a potential performance issue is detected. This is applied to storage systems having a cluster of multiple nodes in the form of components such as storage servers, with the nodes providing redundancy for sharing a load of host input/output (IO) operations.

A method, system, and computer program product are provided for a performance sensitive storage system upgrade in a storage system having a cluster of multiple nodes with redundancy for sharing a load of host IO operations. The method upgrades one of more nodes at a time making use of redundancy and collects performance statistics of the storage system with currently upgraded nodes during active use of the host IO operations. The method compares the collected performance statistics with historical performance statistics for the storage system, and, if the upgraded nodes show a negative performance impact, takes remedial action, otherwise, continues to upgrade the remaining nodes.

More specifically, according to an aspect of the present disclosure there is provided a computer-implemented method for performance sensitive storage system upgrade, comprising: providing a storage system having a cluster of multiple nodes with redundancy for sharing a load of host input/output (IO) operations; upgrading one or more nodes at a time making use of redundancy; collecting performance statistics of the storage system with currently upgraded nodes during active use of the host IO operations; and comparing the collected performance statistics with historical performance statistics for the storage system, wherein: if the upgraded nodes show a negative performance impact, taking remedial action; otherwise, continuing to upgrade the remaining nodes.

According to another aspect of the present disclosure there is provided a system for performance sensitive storage system upgrade, comprising: a storage system having a cluster of multiple nodes with redundancy for sharing a load of host input/output (IO) operations and storage controller including a processor and a memory configured to provide computer program instructions to the processor to execute the function of the components: a node upgrade component for upgrading one or more nodes at a time making use of redundancy; a statistic collecting component for collecting performance statistics of the storage system with currently upgraded nodes during active use of the host IO operations; and a performance comparing component for comparing the collected performance statistics with historical performance statistics for the storage system; and a remedial action component for, if the upgraded nodes show a negative performance impact, taking remedial action.

According to a further aspect of the present disclosure there is provided a computer program product for performance sensitive storage system upgrade, the computer program product comprising a computer readable storage medium having program instructions embodied therewith, the program instructions executable by a processor to cause the processor to: provide a storage system having a cluster of multiple nodes with redundancy for sharing a load of host input/output (IO) operations; upgrade one or more nodes at a time making use of redundancy; collect performance statistics of the storage system with currently upgraded nodes during active use of the host IO operations; and compare the collected performance statistics with historical performance statistics for the storage system, wherein: if the upgraded nodes show a negative performance impact, taking remedial action; otherwise, continuing to upgrade the remaining nodes.

The computer readable storage medium may be a non-transitory computer readable storage medium and the computer readable program code may be executable by a processing circuit.

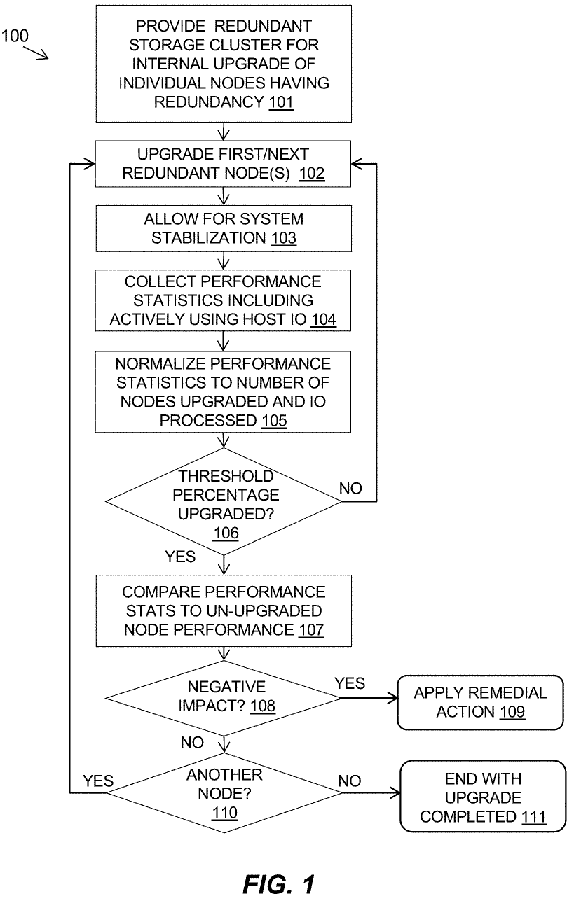

Referring now to FIG. 1, a flow diagram 100 shows an example embodiment of the described method. In some embodiments, the method may be performed by a processor and/or a processor in a computing system. The method includes identifying/providing 101 a storage system having a cluster of multiple nodes with redundancy for sharing a load of host IO operations.

The method may upgrade 102 one or more nodes, upgrading a number of nodes at a time making use of redundancy such that the node(s) being upgraded do not affect the clustered system. The number of nodes upgraded at a time is dependent on the redundancy of the storage system. If the storage system supports the failure of only one node, only one node will be upgraded at a time. Whereas if the storage system has redundancy to support more than one node failure, more than one node may be upgraded at the same time. Taking out a node for upgrade purposes effectively means that the system loses some redundancy; therefore, it is favored to limit the upgrade to a small number of nodes at any given time.

As the one or more nodes are upgraded, the method may allow 103 a period of time for the system to stabilize with the upgraded node(s). Due to the way hosts handle failover, it may be that it takes the paths some time to get reused, which may cause the upgrade of the next one or more nodes to delay until the performance statistics collection is satisfied.

Once stabilized, the method collects 104 performance statistics of the storage system with the currently upgraded nodes during active use of the host IO operations. Collecting the performance statistics includes actively using the host IO to understand if the upgrade will have negative impact on the storage system. Performance statistics may include, but are not limited to, the following: IO latency (size-aware); IO throughput; IO amplification; CPU utilization; and memory consumption. The performance statistics may also monitor the behavior and performance profile of the backend media.

In this way, the system is upgraded one or more nodes at a time, while collecting performance statistics. The performance statistics may be normalized 105 to a number of nodes upgraded and IO operations processed by the system.

The method compares 107 the collected performance statistics of the system including the upgraded nodes to historical performance statistics or profiles of the storage system including not-yet-upgraded nodes. Based on the results of the comparison the upgrade process can take actions, ranging from progressing with the upgrade, rolling back, and/or alerting the user or any other action.

The comparison 107 may be carried out after every, one node upgrade or it may wait for a threshold percentage or number of nodes to have been upgraded; for example, a configured percentage threshold may be set such as 50% of the nodes of the system upgraded.

In an embodiment in which the comparison 107 is carried out at every one or more node upgrade, less accurate results may be yielded in some conditions due to imbalanced workload between the different code levels; however, it may allow a more flexible upgrade abortion behavior.

In an embodiment in which a threshold percentage is applied, more accurate performance results may be obtained. The method may determine 106 if a threshold percentage of nodes has been upgraded. If the threshold percentage has not yet been reached, the method loops to upgrade a next one or more node. If the threshold percentage has been reached, the comparison 107 is carried out.

The method may determine 108 if the upgrade has had a negative impact on performance of the storage system. The method may include a user-defined tolerance setting to the performance comparison, making sure that small “blips” in the system (e.g., a drive suddenly goes slow, minor network issue, etc.) do not prevent the upgrade from completing.

If there is a negative performance impact, remedial action may be applied 109 such as requiring user input or aborting and rolling back of the upgraded nodes. Examples of user input may include: continuing with the upgrade even though there are negative performance indications; pausing for further analysis; and attempt another node and collecting further data for comparison.

The performance comparison is carried out internally rather than depending on an outside piece of software, allowing action to be taken by the storage system itself to prompt the user as to whether they wish to continue.

If there is no negative performance impact, the method may continue with the upgrading process by determining 110 if there is another node to be upgraded and, if so, continuing with the upgrade. If there are no further nodes to upgrade, the method may end 111 with the upgrade to the storage system having been completed.

The described method may be applied to a large variety of environments and monitors in which an internal upgrade is carried out of a storage system cluster.

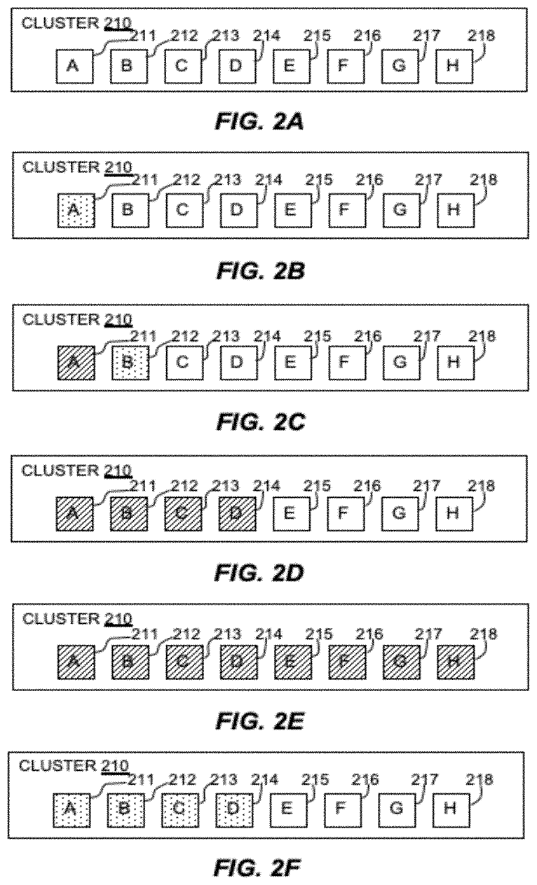

Referring to FIGS. 2A to 2F, schematic diagrams show an example embodiment of a cluster 210 of a storage system including nodes 211-218 that may be in the form of storage servers or other designated components that can be upgraded individually.

FIG. 2A shows the cluster 210 in a pre-upgrade condition that holds historic performance statistics.

FIG. 2B shows a first node 211 as being upgraded and starting to collect performance statistics. Once the performance statistics of the first node 211 are usable, a second node 212 is upgraded as shown in FIG. 2C.

FIG. 2D, shows that four of the nodes 211-214, which is 50% of the nodes 211-218, have been upgraded and are running new code and have usable statistics. A comparison is carried out of the collected performance statistics of the upgraded nodes 211-214 to the historic performance statistics of the cluster 210 at the pre-upgrade stage of FIG. 2A.

If no performance impact is detected, the upgrade can complete as shown in FIG. 2E. Alternatively in cases where issues are detected, the upgrade is suspended as shown in FIG. 2F until user input is provided.

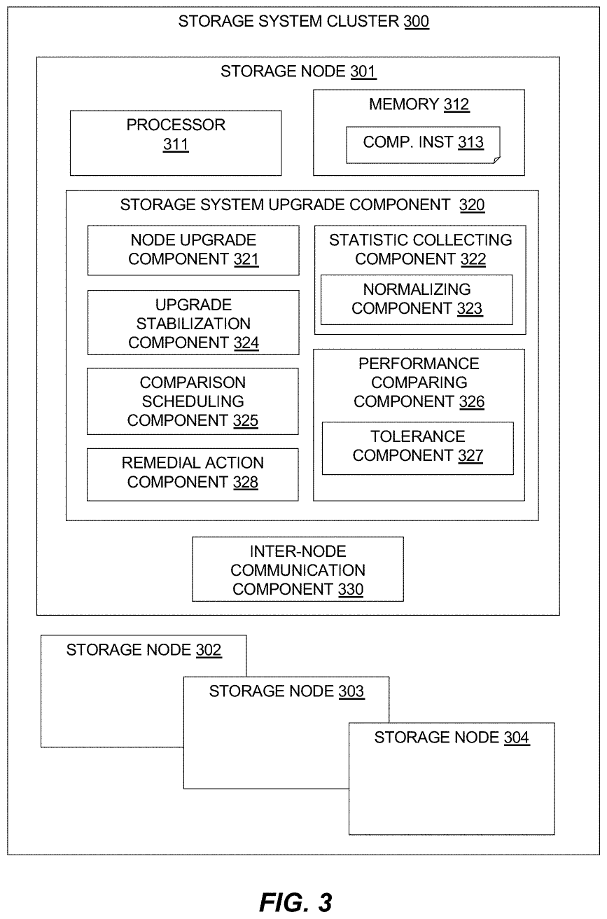

Referring to FIG. 3, a block diagram shows an example embodiment of a storage system cluster 300 including multiple storage nodes 301-304. Each storage node 301-304 includes a storage controller at which a storage system upgrade component 320 may be implemented. A storage system cluster 300 may typically include an even number of nodes, or an even number and some spare nodes, ranging from two to eight nodes. However, very distributed storage systems may have tens of nodes. Each storage node 301-304 includes an inter-node communication component 330 to enable communication between the nodes 301-304.

The storage node 301 may include at least one processor 311, a hardware module, or a circuit for executing the functions of the described components which may be software units executing on the at least one processor. Multiple processors running parallel processing threads may be provided enabling parallel processing of some or all of the functions of the components. Memory 312 may be configured to provide computer instructions 313 to the at least one processor 311 to carry out the functionality of the components.

The storage system upgrade component 320 includes a node upgrade component 321 for upgrading one or more nodes at a time making use of redundancy in the cluster.

The storage system upgrade component 320 includes a statistic collecting component 322 for collecting performance statistics of the storage system with currently upgraded nodes during active use of the host IO operations. The statistic collecting component 322 may collect performance measurements after each node upgrade and may include a normalizing component 323 for normalizing the performance statistics to a number of nodes upgraded and to the IO performed.

The storage system upgrade component 320 may include an upgrade stabilization component 324 for pacing the upgrading of one or more node at a time and, after each upgrade, allowing for stabilization of performance statistics.

The storage system upgrade component 320 may include a performance comparing component 326 for comparing the collected performance statistics with historical performance statistics for the storage system. The performance comparing component 326 may include a tolerance component 327 for allowing a defined tolerance to a measure of negative performance impact.

The storage system upgrade component 320 may include a comparison scheduling component 325 for comparing the collected performance statistics with historical performance statistics for the storage system. The comparison scheduling component 325 may schedule the comparison after each one or more node is upgraded or once a threshold percentage of the nodes have been upgraded.

The storage system upgrade component 320 may include a remedial action component 328 for, if the upgraded nodes show a negative performance impact, taking remedial action automatically or subject to input by a user.

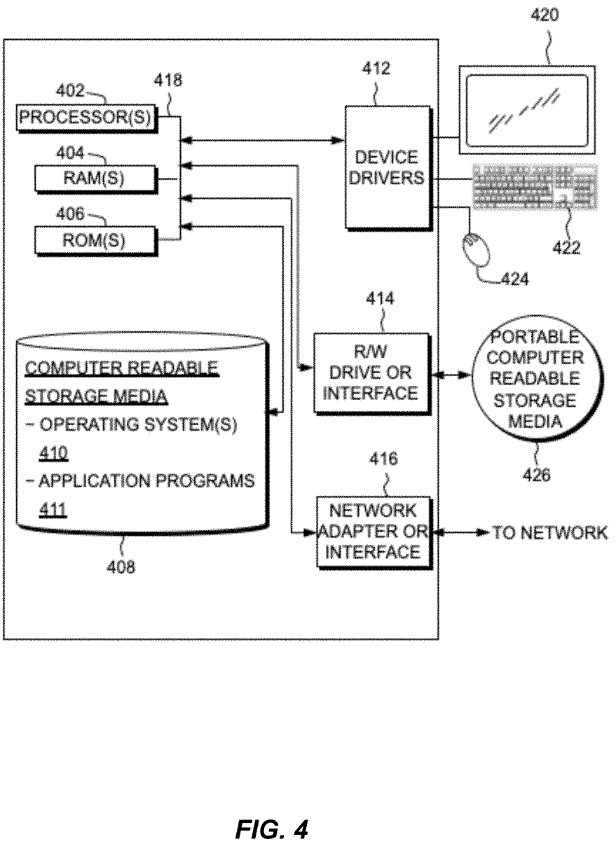

FIG. 4 depicts a block diagram of components of a computing system such as the storage node 301 of FIG. 3, in accordance with an embodiment of the present disclosure. It should be appreciated that FIG. 4 provides only an illustration of one implementation and does not imply any limitations with regard to the environments in which different embodiments may be implemented. Many modifications to the depicted environment may be made.

The computing system can include one or more processors 402, one or more computer-readable RAMs 404, one or more computer-readable ROMs 406, one or more computer readable storage media 408, device drivers 412, read/write drive or interface 414, and network adapter or interface 416, all interconnected over a communications fabric 418. Communications fabric 418 can be implemented with any architecture designed for passing data and/or control information between processors (such as microprocessors, communications and network processors, etc.), system memory, peripheral devices, and any other hardware components within the system.

One or more operating systems 410, and application programs 411, such as the storage system upgrade component 320 are stored on one or more of the computer readable storage media 408 for execution by one or more of the processors 402 via one or more of the respective RAMs 404 (which typically include cache memory). In the illustrated embodiment, each of the computer readable storage media 408 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the disclosure.

The computing system can also include a R/W drive or interface 414 to read from and write to one or more portable computer readable storage media 426. Application programs 411 on the computing system can be stored on one or more of the portable computer readable storage media 426, read via the respective R/W drive or interface 414 and loaded into the respective computer readable storage media 408.

The computing system can also include a network adapter or interface 416, such as a TCP/IP adapter card or wireless communication adapter. Application programs 411 on the computing system can be downloaded to the computing device from an external computer or external storage device via a network (for example, the Internet, a local area network or other wide area networks or wireless networks) and network adapter or interface 416. From the network adapter or interface 416, the programs may be loaded into the computer readable storage media 408. The network may comprise copper wires, optical fibers, wireless transmission, routers, firewalls, switches, gateway computers and edge servers.

The computing system can also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414, and network adapter or interface 416 can comprise hardware and software stored in computer readable storage media 408 and/or ROM 406.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

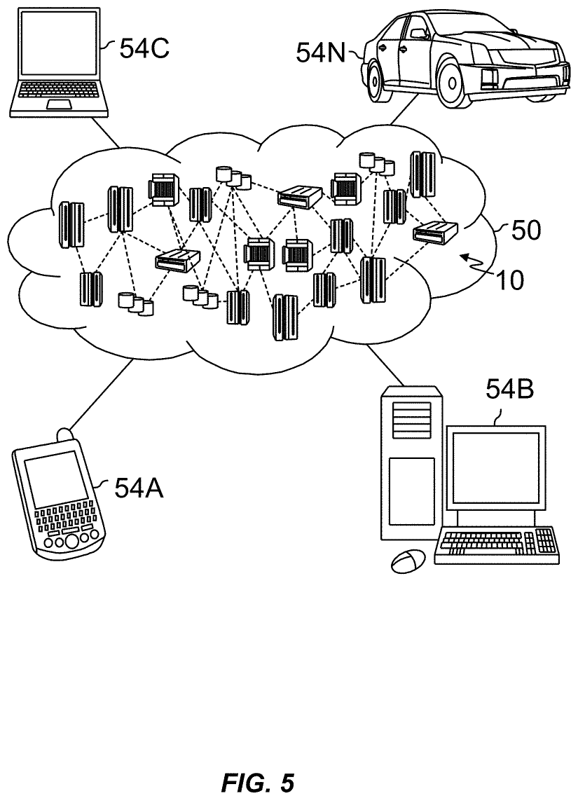

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

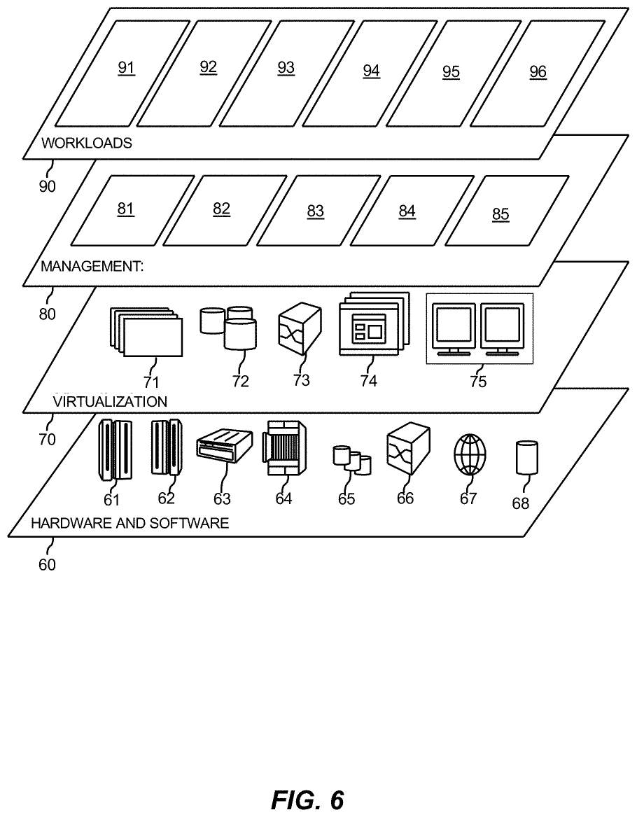

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and storage system upgrade processing 96.

A computer program product of the present disclosure comprises one or more computer readable hardware storage devices having computer readable program code stored therein, said program code executable by one or more processors to implement the methods of the present disclosure.

A computer system of the present disclosure comprises one or more processors, one or more memories, and one or more computer readable hardware storage devices, said one or more hardware storage device containing program code executable by the one or more processors via the one or more memories to implement the methods of the present disclosure.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method for a performance sensitive storage system upgrade, comprising:
identifying a storage system having a cluster of multiple nodes with redundancy for sharing a load of host input/output (IO) operations;
upgrading one or more nodes at a time making use of redundancy;
collecting performance statistics of the storage system with the upgraded nodes during active use of the host IO operations; and
comparing the collected performance statistics with historical performance statistics for the storage system, wherein:
if the upgraded nodes show a negative performance impact, taking remedial action;
otherwise, continuing to upgrade the remaining nodes.

2. The method as claimed in claim 1, including, after each node upgrade, collecting performance measurements.

3. The method as claimed in claim 1, including pacing the upgrading of the one or more nodes at a time and, after each upgrade, allowing for stabilization of performance statistics.

4. The method as claimed in claim 1, wherein collecting performance statistics includes normalizing the performance statistics to a number of nodes upgraded and to the IO performed.

5. The method as claimed in claim 1, wherein comparing the collected performance statistics with historical performance statistics for the storage system nodes is carried out for each one or more node upgrade.

6. The method as claimed in claim 1, wherein comparing the collected performance statistics with historical performance statistics for the storage system nodes is carried out once a threshold percentage of the nodes have been upgraded.

7. The method as claimed in claim 6, wherein the threshold percentage is a configured percentage of the nodes.

8. The method as claimed in claim 1, wherein the remedial action is, at least, a roll back of the upgraded nodes, a pause of the upgrade for analysis, and a continuation of the upgrade.

9. The method as claimed in claim 1, wherein a measure of negative performance impact includes a defined tolerance for the comparison.

10. The method as claimed in claim 1, wherein upgrading one or more nodes includes upgrading with, at least, new features, improvement to existing features, new configurations, and code bug fixes.

11. A system for a performance sensitive storage system upgrade, comprising:
a storage system having a cluster of multiple nodes with redundancy for sharing a load of host input/output (IO) operations; and
a storage controller including:
a memory; and
a processor in communication with the memory, the processor being configured to perform operations comprising:
upgrading one or more nodes at a time making use of redundancy;
collecting performance statistics of the storage system with the upgraded nodes during active use of the host IO operations; and
comparing the collected performance statistics with historical performance statistics for the storage system, wherein:
if the upgraded nodes show a negative performance impact, taking remedial action;
otherwise, continuing to upgrade the remaining nodes.

12. The system as claimed in claim 11, including, after each node upgrade, collecting performance measurements.

13. The system as claimed in claim 11, including pacing the upgrading of the one or more nodes at a time and, after each upgrade, allowing for stabilization of performance statistics.

14. The system as claimed in claim 11, wherein collecting performance statistics includes normalizing the performance statistics to a number of nodes upgraded and to the IO performed.

15. The system as claimed in claim 11, wherein comparing the collected performance statistics with historical performance statistics for the storage system nodes is carried out for each one or more node upgrade.

16. The system as claimed in claim 11, wherein comparing the collected performance statistics with historical performance statistics for the storage system nodes is carried out once a threshold percentage of the nodes have been upgraded.

17. The system as claimed in claim 16, wherein the threshold percentage is a configured percentage of the nodes.

18. The system as claimed in claim 11, wherein a measure of negative performance impact includes a defined tolerance for the comparison.

19. A computer program product for a performance sensitive storage system upgrade, the computer program product comprising a computer readable storage medium having program instructions embodied therewith, the program instructions executable by a processor to cause the processor to perform the operations of:
identifying a storage system having a cluster of multiple nodes with redundancy for sharing a load of host input/output (IO) operations;
upgrading one or more nodes at a time making use of redundancy;
collecting performance statistics of the storage system with the upgraded nodes during active use of the host IO operations; and
comparing the collected performance statistics with historical performance statistics for the storage system, wherein:
if the upgraded nodes show a negative performance impact, taking remedial action;
otherwise, continuing to upgrade the remaining nodes.

20. The computer program product as claimed in claim 19, wherein comparing the collected performance statistics with historical performance statistics for the storage system nodes is carried out once a threshold percentage of the nodes have been upgraded.
